(19) United States
(12) Patent Application Publication
(10) Pub. No.: US 2018/0018744 A1
(43) Pub. Date: Jan. 18, 2018

(54) SYSTEM AND METHOD FOR PROVISIONING EXPENSES FOR A TRAVEL EVENT

(71) Applicant: Pallav Jha, Kota (IN)

(72) Inventor: Pallav Jha, Kota (IN)

(21) Appl. No.: 15/210,656

(22) Filed: Jul. 14, 2016

(51) Int. Cl. G06Q 50/14; G06Q 40/08

(52) U.S. Cl. CPC G06Q 50/14; G06Q 40/08

(57) ABSTRACT

A system and a method for provisioning expenses for a travel event is disclosed. The method comprises receiving a subscription request from a user, comprising a plurality of travel events, for availing expenses for the travel events. The subscription request is checked with a pre-defined criteria. The method further comprises receiving a claim request for provisioning of the expenses for a travel event. The claim request is received with a documentary evidence. Further, the claim request and the documentary evidence are verified with the subscription request and pre-defined criteria. Furthermore, the expenses are provisioned to the user upon verifying the claim request and the documentary evidence.

### FIELD OF INVENTION

The present disclosure relates to a field of provisioning expenses. More specifically, the present disclosure relates to a system and method for provisioning expenses for a travel event occurred during an emergency.

### BACKGROUND

As known, a large share of the labor force in middle-eastern countries are immigrants from countries such as India, Bangladesh, Pakistan, Sri Lanka, Indonesia and Philippines. It is estimated that about 6 million people from different nationalities are working as blue-collared workers or employees in the Gulf Cooperation Council (GCC). Typically, the employees spend three-quarters of their income to support their families in their home country. The employees tend to use the remaining income to fulfill basic needs. As a result, the employees may not have an emergency fund to cater to a need such as travelling, in case of an emergency. For example, the emergency may be death of a close family member, birth of an off spring, critical illness, a natural calamity and so on. During the emergency, the employees may have to travel to their home country to take care of their kin. Due to insufficient monies or lack of the emergency fund, it is very difficult to arrange for funds that can be utilized for travel expenses. At times, the employees may have to avail a loan to pay for their expenses incurred. As a result, a huge financial burden is added for the employees.

In the existing art, organizations provide travel reimbursement services to their employees. Generally, the organization defines a policy under which the employees may claim for a reimbursement for the expenses incurred during their travel. In the existing art, the expenses are reimbursed to the employees by the organization, only when the travel is made on behalf of the organization. Further, a travel policy of an organization may require tickets to be reserved before a certain period of time. Further, the travel policy may impose restrictions on class of the tickets and accommodation. If the class of the tickets and accommodation are different from those in the travel policy, then the organization may deny reimbursement of expenses. The reimbursement method of the above type cannot be implemented in situations other than in organizations. In other words, the travel policy is limited to an organization and may not address a certain class of employees, especially employees with low earnings, working across different organizations.

Another example of travel expense reimbursement may include airline industry or air travel service providers. For instance, airlines may provide a compassionate or bereavement fare for users who wish to visit dying relatives or for attending a funeral of a deceased relative. The compassionate fare essentially involves providing a discount to the user on a standard airline ticket booked on an urgent basis. For example, the compassionate fare policy may determine that the user may get 50 percent discount on the standard fare if the users' relative is critically ill. In another example, the compassionate fare policy may determine that the user may get 80 percent discount on the standard fare if the users' relative is deceased. Similarly, the compassionate fare policy may determine conditions upon which the user may claim for obtaining reimbursement on the expenses incurred for travel. In order to avail the compassionate fare, the user may pay the standard fare at the time of booking for travel. After attending to the event such as death of a relative, the user may claim for reimbursement under the compassionate fare policy. The user may submit documents for verifying the occurrence of the event. Subsequently, the airline may verify the documents, check the policy to refund certain amount as per the policy. The above process is cumbersome and requires a lot of resources to validate the differences in fare, verifying documents, assessing the reason for travel and so on.

### SUMMARY

This summary is provided to introduce concepts related to a system and a method for reimbursing expenses incurred during a travel event and the concepts are further described below in the detailed description. This summary is not intended to identify essential features of the claimed subject matter nor is it intended for use in determining or limiting the scope of the claimed subject matter.

In one example, a method for provisioning expenses for a travel event is disclosed. The method comprises receiving, by a processor, a subscription request from a user. The subscription request comprises a plurality of travel events, for availing expenses for the travel events. Further, the subscription request is checked, by the processor, with a pre-defined criteria. The pre-defined criteria indicate conditions for accepting the subscription request. A claim request for provisioning of the expenses for a travel event is received, by the processor, from the user with a documentary evidence. The claim request and the documentary evidence are verified, by the processor, with the subscription request and the pre-defined criteria. The expenses are provisioned to the user upon verifying the claim request and documentary evidence.

In another example, a system for provisioning expenses for a travel event is disclosed. The system comprises a processor and a memory coupled to the processor. The processor executes program instructions stored in the memory to receive a subscription request from a user. The subscription request comprises a plurality of travel events, for availing expenses for the travel events. Further, the subscription request is checked with a pre-defined criteria. The pre-defined criteria indicate conditions for accepting the subscription request. The processor further executes the program instructions to receive a claim request for provisioning of the expenses for a travel event with a documentary evidence from the user. The processor further executes the program instructions to verify the claim request and the documentary evidence with the subscription request and the pre-defined criteria. Furthermore, the processor further executes the program instructions to provision the expenses to the user, upon verifying the claim request and documentary evidence.

In another example, a non-transitory computer readable storage medium comprising program instructions which, when executed, are configured to perform a method for provisioning expenses for a travel event is disclosed. The method comprises receiving a subscription request from a user. The subscription request comprises a plurality of travel events for availing provision of expenses for the travel events. Further, the subscription request is checked with a pre-defined criteria. The pre-defined criteria indicate conditions for accepting the subscription request. A claim request for provisioning of the expenses for a travel event is received from the user with a documentary evidence. The claim request and the documentary evidence are verified with the subscription request and the pre-defined criteria. The expenses are provisioned to the user, upon verifying the claim request and documentary evidence.

### BRIEF DESCRIPTION OF FIGURES

In the following drawings like reference numbers are used to refer to like elements. Although the following figures depict various examples of the invention, the invention is not limited to the examples depicted in the figures.

FIG. 1 illustrates a network implementation of a system for provisioning expenses for a travel event, in accordance with one embodiment of the present disclosure; and

FIG. 2 shows a flowchart for provisioning expenses for a travel event, in accordance with one embodiment of the present disclosure.

### DETAILED DESCRIPTION

The following detailed description is intended to provide example implementations to one of ordinary skill in the art, and is not intended to limit the invention to the explicit disclosure, as one of ordinary skill in the art will understand that variations can be substituted that are within the scope of the invention as described.

The present disclosure discloses a system and method for provisioning expenses for a travel event, to a user. Typically, the user is an immigrant who is required to travel, on an urgent basis, to his home country or to work location. In order to avail expenses for the travel events, the user has to subscribe to the system.

The system receives a subscription request from the user. The subscription request comprises personal details such as name, age, contact number, address, salary details, details of VISA and details of his dependents along with proofs of identity. Further, the user provides a plurality of travel events in the subscription request, for which the provision of expenses may be availed. The plurality of travel events provided by the user may comprise of critical illness of a dependent, birth of an offspring or a natural calamity. The user further specifies a mode of payment for subscribing to the subscription request. After providing the details of the personal details and the plurality of events, the subscription request is submitted to the system. Subsequently, the subscription request is checked with a pre-defined criteria. The pre-defined criteria may comprise various conditions such as a minimum and maximum wage limit, an age limit and a valid worker's VISA. Upon checking with the pre-defined criteria, the subscription request is accepted and saved in the system.

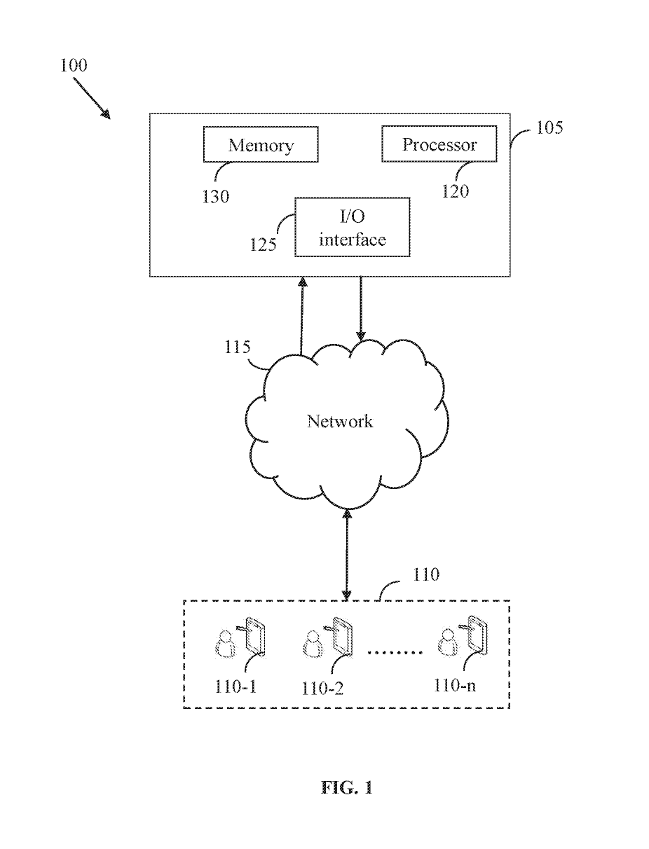

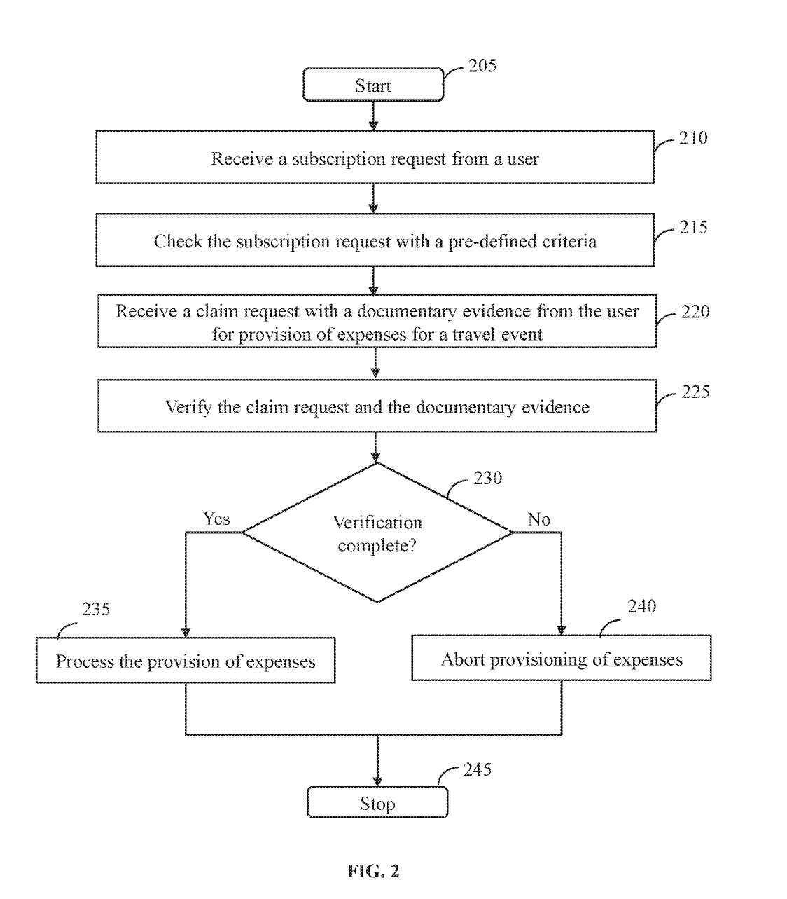

In case of an emergency, the user buys a ticket and attends to the emergency in his home country. On returning from the home country, the user makes a claim request to the system along with a documentary evidence to support the claim request. The claim request and the documentary evidence are verified based on the subscription request and the pre-defined criteria. Typically, the system verifies whether the emergency attended to, by the user is one amongst the plurality of travel events present in the subscription request. Further, the system verifies the details given in the documentary evidence. Upon verification, the claim request is processed and a sum of money in accordance with the pre-defined criteria is reimbursed to the user. Various embodiments of implementing reimbursing expenses incurred during a travel event is explained using the FIGS. 1 and 2.

Referring to FIG. 1, an environment 100 of a system 105 for provisioning expenses for a travel event is illustrated, in accordance with various embodiments of the invention. Although the present disclosure is explained by considering that the system 105 is implemented on a server, it may be understood that the system 105 may also be implemented in a variety of computing systems, such as a mainframe computer, a network server, cloud, and the like. It will be understood that the system 105 may be accessed by multiple users through one or more user devices 110-1, 110-2, . . . 110-n, collectively referred to as user devices 110 hereinafter, or applications residing on the user devices 110. Examples of the user devices 110 may include, but are not limited to, a portable computer, a personal digital assistant, a handheld device, and a workstation. The user devices 110 are communicatively coupled to the system 105 through a network 115.

In one implementation, the network 115 may be a wireless network, a wired network or a combination thereof. The network 115 can be implemented as one of the different types of networks, such as intranet, local area network (LAN), wide area network (WAN), the internet, and the like. The network 115 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 115 may include a variety of network devices, including routers, bridges, servers, computing devices, storage devices, and the like.

In one embodiment, the system 105 may include at least one processor 120, an input/output (I/O) interface 125, a memory 130, and a moderator 140. The at least one processor 120 may be implemented as one or more microprocessors, microcomputers, microcontrollers, digital signal processors, central processing units, state machines, logic circuitries, and/or any devices that manipulate signals based on operational instructions. Among other capabilities, the at least one processor 120 is configured to fetch and execute computer-readable instructions stored in the memory 130.

The I/O interface 125 may include a variety of software and hardware interfaces, for example, a web interface, a graphical user interface, and the like. The I/O interface 125 may allow the system 105 to interact with a user directly or through the user devices 110. Further, the I/O interface 125 may enable the system 105 to communicate with other computing devices, such as web servers and external data servers (not shown). The I/O interface 125 may facilitate multiple communications within a wide variety of networks and protocol types, including wired networks, for example, LAN, cable, etc., and wireless networks, such as WLAN, cellular, or satellite. The I/O interface 125 may include one or more ports for connecting a number of devices to one another or to another server.

The memory 130 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

In one embodiment of the invention, users of the user devices 110 may access the system 105 via the I/O interface 125. The system 105 may be used by a user to subscribe for reimbursement of expenses incurred during a travel event. Specifically, the travel event is an emergency that requires the user to visit his home country or his family members visiting the user's work location. For example, the travel event may be death of a close relative, critical illness, a natural calamity and so on. In order to subscribe, the user uses the user device 110 to send a subscription request to the system 105.

The subscription request may comprise details of the user such as name, contact details, identification numbers, profession details, details of VISA held and details of dependents. For example, consider the user is an immigrant from India working in the United Arabian Emirates (UAE). The contact details of the user may comprise a phone number, current address in the UAE, address while in India and nearest airport to the user's hometown. Further, the identification numbers may be provided by entering an Emirates ID number and an Indian ID number. In one example, a copy of the Emirates ID and the Indian ID may be uploaded to the system 105. Further, the profession details may indicate monthly salary, nature of job and name of the employer of the user. The details of the VISA indicates a type of VISA held by the user. For example, the details of the VISA may include validity of the VISA. Furthermore, the user provides details of dependents such as their names, their relationship with the user and their national IDs. The number of dependents may be limited to a pre-defined number e.g., a maximum of four dependents. In the above example, the user may nominate his father, mother, wife and son. In another example, the type of VISA may include, the VISA that is issued to foreign nationals to work as contract employees in a particular country.

The subscription request further comprises a plurality of travel events for which the user wishes to get reimbursement for the expenses incurred during the travel period. In the above example, the user may provide a plurality of travel events such as death of a dependent, critical illness of a dependent amounting to inability to work, birth of an offspring and natural calamities. The user may avail reimbursement of expenses incurred only during the travel events of the user and the dependents provided in the subscription request. Consequently, if the user travels to India e.g., to visit his dependents following a natural disaster such as heavy rains and floods, then the user may be eligible to get reimbursement of expenses under the travel event of natural calamities.

In order to process and enable the subscription request, the system 105 may request the user to pay a premium. The premium indicates an amount that has to be paid to avail the expenses reimbursed for the travel events chosen by the user. The user may choose to pay the premium upfront or may choose to pay in small amounts at regular intervals e.g., monthly, quarterly, yearly and so on. Consider the subscription request for a year costs 360 AED, then the user may opt to pay a premium of 360 AED upfront or may choose to pay a premium of 30 AED every month for a year.

In order to reduce burden on the user, the system 105 may receive the premium through a central wage processing system. The central wage processing system is a bank through which employer of the user processes the salary to the user. When the employer pays the salary to the user, at first, the salary is sent to the central wage processing system and then the salary is deposited into account of the user. In order to reduce the burden of paying the premium every month, the user may authorize the system 105 to withdraw the premium from the central wage processing system. In other words, the system 105 is integrated with the central wage processing system. In order to explain receiving the premium through the central wage processing system, an example may be used. Consider the user receives a salary of 400 AED per month from the employer. Further, consider the user committed to pay the premium of 30 AED per month for the subscription request. When the salary is to be paid to the user, the employer pays AED 400 to the central wage processing system. The central wage processing system submits 370 AED to the account of the user and 30 AED to the system 105. In other words, integration of the central wage processing system with the system 105 allows for automated collection of premiums from the user's account in the central wage processing system. After submitting the premium, the details of the subscription request and the premium is stored in the memory 130.

After receiving details of the subscription request, the system 105 checks the subscription request with a pre-defined criteria. The pre-defined criteria indicate conditions for accepting and processing the subscription request. In one example, the pre-defined criteria may comprise an age limit, a minimum and maximum wage limit and a valid worker's VISA, a maximum number of dependents and so on. The age limit may indicate a condition that age of the user should be 18 to 55. The minimum and maximum wage limit may indicate the salary of the user in a given range. The minimum and maximum wage limit is specified such that the users of certain income group are eligible for availing the reimbursement. For example, the minimum and maximum wage limit for the users may be set as 1500 AED to 10000 AED per year such that the users earning within the limit specified are eligible to apply for the subscription request. Similarly, the users having a certain type of VISAs are considered to be eligible to apply for the subscription request. In addition, the pre-defined criteria may include a condition specifying an amount that would be reimbursed based on the travel event and the premium paid towards the subscription request. The user may submit documents as a proof for validating the age, wage limit, type of VISA, and so on.

Based on the above, for each of the details provided in the subscription request, the system 105 checks the details with the pre-defined criteria. If the details match with the pre-defined criteria, then the subscription request is accepted by the system 105. Upon checking the subscription request with the pre-defined criteria, the system 105 stores the details of the user along with the documents uploaded, in the memory 130.

In order to explain checking of the subscription request with the pre-defined criteria, an example may be used. Consider the pre-defined criteria comprises—Maximum age of the user should be 55, User should have a valid VISA for 6 years, Salary range should be between 1500 AED to 10000 AED, minimum premium to be paid per month is 30 AED Maximum number of dependents is 3, and so on. Now, consider the details of the user comprises—Age is 35, VISA is valid for 10 years, Salary is 5000 AED, has 3 dependents, and premium paid per month is 80 AED. For the above example, the system 105 checks the subscription request with the pre-defined criteria and accepts the subscription request as all the pre-defined criteria are met. If the subscription request does not match with the pre-defined criteria, then the system 105 may request the user to submit additional details or may reject the subscription request.

Upon accepting the subscription request, in case of a travel event related to an emergency, the user buys a ticket to his home country. In other words, the user pays for the expenses incurred to travel to his home country. After attending to the emergency, the user makes a claim request for reimbursement of the expenses for the travel event along with a documentary evidence. The documentary evidence indicates a support document to prove that the travel event has occurred. For example, when the user travel to his home country, an air ticket may be submitted as the documentary evidence to prove that the travel event has occurred. The user may submit the claim request along with the documentary evidence through the user device 110.

In another embodiment, the system 105 may provision expenses related to a travel event, to the user, prior to the travel event. In order to get the expenses provisioned, the user may submit details of the travel event to the system 105. For example, consider the user wishes to travel to his home country. The user may submit his details such as date of journey, a source of obtaining tickets, estimated price of the tickets as per the source of obtaining the tickets as a documentary evidence for the travel event to the system 105. Based on the details of the travel event, the user submits a claim request for obtaining the expenses from the system 105.

After receiving the claim request along with the documentary evidence, the system 105 verifies the claim request and the documentary evidence against the subscription request and the pre-defined criteria. Further, the system 105 may request for a supplementary documentary evidence if the documentary evidence submitted is insufficient. Furthermore, if the supplementary documentary evidence is found to be incomplete, then the system 105 denies the provisioning or reimbursement of the expenses.

If the documentary evidence is complete, then the system 105 processes the provisioning or reimbursement of the expenses for the travel event. Based on the travel event and the expenses incurred, the system 105 checks with the pre-defined criteria to provision the expenses. The system 105 may provision or reimburse the expenses to the user through a mode of payment provided in the subscription request. Typically, the mode of payment is through a bank, an exchange house or the central wage processing system.

The present disclosure is explained considering an example. Consider, a user subscribes to the system 105 for reimbursement of expenses incurred during a travel event. The user is an immigrant from Bangladesh working in UAE region. The user may use the user device 110, e.g., a mobile phone to interact with the system 105. The user may submit a subscription request to the system 105 through the user device 110. The subscription request comprises personal details of the user and details of dependents. The user may list his mother, father and brother as the dependents. The subscription request further comprises a plurality of travel events for which the reimbursement of expenses may be availed. The plurality of travel events provided by the user may comprise a critical illness of a dependent, death of a dependent and a natural calamity. Furthermore, the user opts to pay a premium of 360 AED annually (30 AED=12 months) through the central wage processing system integrated with the system 105.

After receiving the subscription request, the system 105 may check the subscription request with a pre-defined criteria. The pre-defined criteria may comprise an annual income in the range of 1000 AED to 4000 AED and a valid worker's VISA. Consider the user has an annual income of 2500 AED and worker's VISA valid for the next two years. Based on the details provided in the subscription request and the pre-defined criteria, the system 105 may accept the subscription request.

Consider, the user's brother is also residing in the UAE with the user. The user and his brother wish to visit their ailing mother in Bangladesh. The user buys air tickets for his brother and himself and travels to Bangladesh to attend to the emergency. After returning to the UAE, the user submits a claim request with a documentary evidence to the system 105. The documentary evidence for the travel event may be a medical bill along with the air tickets. The system 105 verifies the documentary evidence with the subscription request and the pre-defined criteria. If the documentary evidence is complete, then the reimbursement of the expenses is processed. The reimbursement of expenses may also be based on conditions specified in the pre-defined criteria. The conditions in the pre-defined criteria may specify that the expenses may be fully reimbursed only when the class of air ticket is economy class. If the conditions specified in the pre-defined criteria are met, then the expenses are reimbursed through the central wage processing system. If the documentary evidences are found to be incomplete, then the system 105 requests the user to submit a supplementary documentary evidence. The supplementary documentary evidence may be a doctor's certificate. If the supplementary documentary evidence submitted is incomplete, then the system 105 may deny the reimbursement of the expenses to the user.

In another embodiment, the system 105 may provision expenses related to a travel event, to the user, prior to the travel event. In order to get the expenses provisioned, the user may submit details such as date of journey, a source of obtaining tickets, estimated price of the tickets as per the source of obtaining the tickets, a documentary evidence for the travel event and so on. The system 105 may provision an amount to the user, based on conditions specified in the pre-defined criteria.

In the above example, consider, the user wishes to visit his mother in a critical condition. The user may have scheduled an appointment, for his mother, with a doctor in Bangladesh. The user may submit a claim request to the system 105 specifying the travel event as critical illness of a dependent. Further, the user may submit details such as date of journey, a source of obtaining tickets and an estimated price of tickets, in the claim request. The source of obtaining the tickets may be an e-ticketing portal, which also gives the estimated price of tickets. Further, the user may provide a medical appointment letter as documentary evidence for the travel event. The system 105 verifies the claim request and the documentary evidence with the subscription request and the pre-defined criteria. The provisioning of expenses is processed, by the system 105, based on the completeness of the documentary evidence and the conditions specified in the pre-defined criteria.

In the present example, the user who is an immigrant, is provisioned the expenses for visiting a dependent in the home country. As mentioned earlier, the user may travel to his home country to visit his dependent who might be ill or deceased, or due to a natural calamity in his home country.

In another example, the user may subscribe to the system from his home country. The dependent may be travelling or might be a resident in a foreign country. If the dependent falls ill or to if there is a natural calamity in the foreign country, then the user might travel to the foreign country. Subsequently, the user may claim reimbursement for the expenses incurred during the travel by submitting documentary evidence to the system upon returning to the home country.

The system helps users having low earnings and having particular type of visa in managing unplanned expenses, resulting from emergency visits to home or another country. In other words, the system lowers financial burden on the users having low earnings. Further, the system 105 makes managing subscriptions from multiple users easy. Furthermore, saving of the subscription requests and other documents in digital format in the memory 130 makes processing of claim requests easier and faster.

Referring now to FIG. 2, a method 200 for provisioning expenses for a travel event is shown, in accordance with an embodiment of the present disclosure. The method 200 may be described in the general context of computer executable instructions. Generally, computer executable instructions may include routines, programs, objects, components, data structures, procedures, modules, functions, etc., that perform particular functions or implement particular abstract data types. The method 200 may also be practiced in a distributed computing environment where functions are performed by remote processing devices that are linked through a communications network. In a distributed computing environment, computer executable instructions may be located in both local and remote computer storage media, including memory storage devices.

The order in which the method 200 is described and is not intended to be construed as a limitation, and any number of the described method blocks can be combined in any order to implement the method 200 or alternate methods. Additionally, individual blocks may be deleted from the method 200 without departing from the spirit and scope of the disclosure described herein. Furthermore, the method may be implemented in any suitable hardware, software, firmware, or combination thereof. However, for ease of explanation, in the embodiments described below, the method 200 may be implemented in the above-described system 105.

The method 200 starts at step 205.

At step 210, a subscription request is received from a user. The subscription request consists of a plurality of travel events for which provision of expenses may be availed.

At step 215, the subscription request is checked with a pre-defined criteria, The pre-defined criteria may comprise a maximum salary limit, a valid worker's VISA and travel events related to the user and his direct dependents.

At step 220, a claim request for provisioning of expenses is received from the user. The user makes the claim request with necessary documentary evidences, after attending to the emergency.

At step 225, the claim request and the documentary evidences are verified against the subscription request and the pre-defined criteria.

At step 230, the documentary evidences are checked to see if they are complete, in order to process the provisioning of expenses. If the documentary evidences are found to be complete, then step 235 is performed. Otherwise, step 240 is performed.

At step 235, the provisioning of expenses is processed. The provisioned money is disbursed through a central wage processing system or to a bank account operated by the user.

At step 240, the provisioning of expenses is aborted.

The process ends at step 245.

Although embodiments of system have been described in language specific to features and/or methods, it is to be understood that the description is not necessarily limited to the specific features or methods described. Rather, the specific features and methods are disclosed as examples of implementations of a system for provisioning expenses for a travel event.

What is claimed is:

1. A method for provisioning expenses for a travel event, the method comprising:
receiving, by a processor, a subscription request from a user, wherein the subscription request comprises a plurality of travel events for availing expenses for the travel events;
checking, by the processor, the subscription request with a pre-defined criteria, wherein the pre-defined criteria indicate conditions for accepting the subscription request;
receiving, by the processor, a claim request for provisioning of the expenses for a travel event, wherein the claim request is received with a documentary evidence;
verifying, by the processor, the claim request and the documentary evidence, wherein the claim request is verified with the subscription request and the pre-defined criteria; and
provisioning, by the processor, the expenses to the user, upon verifying the claim request and the documentary evidence.

2. The method of claim 1, further comprising receiving a payment for the subscription request.

3. The method of claim 1, wherein the travel event comprises one of a critical illness, death of a family member and a natural calamity.

4. The method of claim 1, wherein the pre-defined criteria comprises a maximum wage limit, a valid worker's VISA, a pre-defined type of VISA and emergencies related to the user and his direct dependents.

5. The method of claim 1, further comprising requesting a supplementary documentary evidence when the documentary evidence is incomplete.

6. The method of claim 1, further comprising integrating with a central wage processing system for processing the reimbursement.

7. The method of claim 2, wherein the payment for the subscription request is received from a central wage processing system.

8. A system for provisioning expenses for a travel event, the system comprising:
a processor; and
a memory, coupled to the processor, wherein the memory comprises program instructions to be executed by the processor, to:
receive a subscription request from a user, wherein the subscription request comprises a plurality of travel events, for availing expenses for the travel events;
check the subscription request with a pre-defined criteria, wherein the pre-defined criteria indicate conditions for accepting the subscription request;
receive a claim request for provisioning of the expenses for a travel event, wherein the claim request is received with a documentary evidence;
verify the claim request and the documentary evidence, wherein the claim request is verified with the subscription request and the pre-defined criteria; and
provision the expenses to the user, upon verifying the claim request and the documentary evidence.

9. The system of claim 8, wherein the processor further executes the program instructions to receive a payment for the subscription request.

10. The system of claim 8, wherein the travel event comprises one of a critical illness, death of a family member and a natural calamity.

11. The system of claim 8, wherein the pre-defined criteria comprises a maximum wage limit, a valid worker's VISA, a pre-defined type of VISA and emergencies related to the user and his direct dependents.

12. The system of claim 8, wherein the processor further executes the program instructions to request a supplementary documentary evidence when the documentary evidence is incomplete.

13. The system of claim 8, wherein the processor further executes the program instructions to integrate with a central wage processing system for processing the reimbursement.

14. The system of claim 9, wherein the payment for the subscription request is received from a central wage processing system.

15. A non-transitory computer readable storage medium comprising program instructions which, when executed, are configured to perform a method for provisioning expenses for a travel event, the method comprising:
receiving a subscription request from a user, wherein the subscription request comprises a plurality of travel events, for availing expenses for the travel events;
checking the subscription request with a pre-defined criteria, wherein the pre-defined criteria indicate conditions for accepting the subscription request;
receiving a claim request for provisioning of the expenses for a travel event, wherein the claim request is received with a documentary evidence;
verifying the claim request and the documentary evidence, wherein the claim request is verified with the subscription request and the pre-defined criteria; and
provisioning the expenses to the user, upon verifying the claim request and the documentary evidence.
